(19) United States
(12) Patent Application Publication
(10) Pub. No.: US 2007/0003918 A1
(43) Pub. Date: Jan. 4, 2007

(54) Children's music, story and/or interactive CDs/DVDs personalized to a child's name at a time and place remote from initial delivery to a customer

(76) Inventors: Richard Ackermann, San Diego, CA (US); Kurt Penberg, Carlsbad, CA (US)

Correspondence Address: William C. Fuess;FUESS & DAVIDENAS, Suite 2G, 10951 Sorrento Valley Road, San Diego, CA, 92121-1613, US

(21) Appl. No.: 11/125,658

(22) Filed: May 9, 2005

(51) Int. Cl. G09B 3/00

(52) U.S. Cl. 434/350

(57) ABSTRACT

A purchaser is sold and delivered (1) a digital media in which is contained content of interest to a children but no personalization, and also (2) a personalization computer program executable in receipt of some particular proper name so as to modify the digital media to, upon subsequent use of its content, invoke a particular proper name, therein serving to personalize this subsequent use of the content of the digital media to the particular proper name. The purchaser subsequently (3) executes, normally at a place and a time remote from purchase and delivery, and on a computer of the purchaser in which is present both the digital media and the delivered computer program, the computer program in respect of a particular child's proper name that is both selected and entered into the computer and into its executing program by the purchaser. The digital media is thereby personalized, making that all subsequent use of its content will invoke the particular selected and entered proper name.

### BACKGROUND OF THE INVENTION

1. Field of the Invention

The present invention generally relates to children's music, story and/or activity books and audio-visual recordings that are both (1) delivered on digital media, such as compact disks of the CD and DVD type (circa 2005), and (2) personalized with, inter alia, the child's name.

The present invention specifically relates to improvements in the time, place and manner of the personalization of digitalized stories, activities, music and/or video intended for use by a child.

2. Background Information

2.1 Reasons, Circa 2005, of the Personalization of Stories, Activities Including Coloring Books and Games, Music and/or Video Primarily Intended for Children

It has long been known by parents that children respond strongly to their own name as part of their formation of self-awareness, self-identity, and individual personality. In the modern, digital, age new personalized products for children, starting worth simple storybooks, have, by their commercial and application successes, not only confirmed parental expectations that a child responds better to a better and more personalized learning and play environment, but that the children themselves both like this environment and mature better in it. Indeed, there is scarcely anything negative that can be said about a well-structured educational and acculturation process that, even if not targeted on the requirements of a individual child due to lack of teacher or parental resource, is at least sufficiently personalized to an individual child, particularly by frequent inclusion of the child's name (if not also further circumstances of the child) so as to appear each of relevant, friendly and intimate to the child.

That something that is, as of present, so simple as is the personalization of children's learning and play materials should produce such unalloyed good results demands a wider usage of this technique. It may be that modern media ranging from monitors displaying print to sound to video is, as based on digital technoloy, remote from the “natural world”, and that personalization helps children, in particular, to overcome the innate “strangeness” of the modern, first-world, structured learning and play experiences. Or it may be that machines including computers are cold and distant enough already, and that personalization makes them more compatible with humans, as presently demonstrated with the imparting of “personality” to robots at the MIT Media Laboratory. Or it may be that humans of all ages merely like to hear the sound of their own name, and are, especially as children, more comfortable in harboring the delusion that a machine-rendered media experience is unique to themselves, only.

2.2 General State Circa 2005, of the Personalization of Stories Activities Including Coloring Books and Games, Music and/or Video Primarily Intended for Children

Over the course of the past ten years increasing numbers of different types of subject matter as is contained in digital media has been personalized for children. Beyond the basic affixation of book labels denoting ownership to books, the first personalization of media for children involved the text (only) of digitalized storybooks. Placement of custom information such as a particular child's name within the digital texts was analogous to the “mail merge” capabilities of contemporaneous word processing programs. Over the course of years stories have now become to be personalized in quite sophisticated manners, where any of the parents, geographical location, named friends, gender, favorite hobbies and activities, and like information concerning a particular child may be “blended in” to a stock story in order to customize the story for the child.

The personalization of both (1) music, or songs, (3) graphic, and also (3) activity books, transpired next. Music personalization was (and is) realized when generally short tracks where recording artists sung the name of a particular child were digitally merged into longer musical works. Graphics were selectively included relevant to the presented story—which story was itself increasingly personalized to a particular child. Finally, activity books (1) might stress (by more frequent inclusion) any of coloring, puzzle, and like activities preferred by an individual child, as well as (2) making all activities suitable to the age and development of the individual child.

Personalization of video is expected next. A cartoon-like character bearing the child's name and similar in general appearance to the child will probably first appear in video vignettes, followed by longer and more highly customized presentations as technology permits.

2.3 Problems and Limitations, Circa 2005, of the Personalization of Stories, Activities Including Coloring Books and Games, Music and/or Video Primarily Intended for Children

Personalized digital materials for children are, by definition, created on a child-by-child basis.

Even in the case of simple personalized print text—which text may or may not be accompanied by graphics which may or may not be themselves personalized—the generation of this media has historically been centralized at the point(s) of sale. Namely, the personalized books (1) are centrally made by a manufacturer, who may take orders therefor upon a web site or else through agents or dealers, or (2) are made with computers and printers by broker-dealers who are commonly franchisees, and licensees, of each of (2a) patented technology and/or creation methods, (2b) custom computer software programs performing the customization, and (3c) copyrighted content.

Even though a computer literate parent having only word processing skills and minimal equipments can create, and print, a personalized child's story, the supply of these useful (see section 2.2, above) documents has been nearly exclusive commercial, and centralized to point of sale. This has been the case for at least four reasons. First, the personalized story or stories are best bound (bound together) into a book: a storybook. For best appearance and maximum durability of the storybook product given the child, this requires bookbinding equipments not normally possessed by parents or other non-commercial parties. Second, the parent or other amateur party producing the personalization may not have the necessary computer expertise, and even specialty programs directed to this purpose may present such a steep learning curve as makes the project ill advised for the personalization of but a few works for a few different children. Third, the parent or other amateur party producing the personalization may not have access to, nor reproduction rights in, literary materials—i.e., stories, and characters—that are maximum topical interest to the child. Fourth, the parent of or other amateur party producing the personalization may not have access to quality color imaging and printing equipments for the rendering of graphics accompanying the story, and even if equipments like color laser printers are used they often will not conveniently print to both sides of a sheet, and costs are high and quality low relative to mass-printed pages.

According to these reasons, most personalized storybooks are commercially created by the printing of (1) some or all text, and (2) only but some of the graphics, with permissible text overlays on these and pre-existing graphics, so as to create a personalized storybook The cumulative pages—which may be any of—are then assembled inside a cover which may itself be pre-printed, pre-printed-in-part, and/or custom-printed.

Moreover, the requirement for centralized production has been even more acute for the personalization of music, or songs. The computer software for the personalizing of digital music by the melding of musical tracts is normally proprietary, specific to the task at hand, and not suitably loosed—even by licensing—to parties who may not be trustworthy in its protection and use. Second, the musical works, or songs, are normally proprietary. Moreover, the databases of musical “clips” which are inserted within the musical work so as to personalize it to a particular child, are each of extensive, expensive, and of even greater proprietary value. Third, the computer and computer equipments necessary to reliably write a CD, or DVD, are generally equally or more expensive than is a color printer (which may still be required for the album cover!), harder to operate, and harder to transport (such as to a point of sale in a shopping mall).

The challenges to be expected in the personalization of video are even greater.

The present invention will be seen to permit the efficient and effective “in-home” personalization of digital media as contains any of stories, activities, music and, in the future, video. An “un-personalized” digital media, normally a CD or DVD, is still both useful and usable until personalized, which will be seen to be a one-time event. The bottleneck, and delay, or personalization at a point of sale is thus avoided. The proprietary nature of the personalization software of the manufacturer will be seen to be protected.

2.4 Specific Prior Art

Although the digital media personalization system of present invention is believed to be substantially dissimilar from anything heretofore existing or contemplated, certain specific prior art is discussed in the following sections as general background of personalized digital media product, and the industry presently (circa 2005) making these products. For purposes of coherent, the art is grouped by company within the personalization industry.

2.4.1. Create-A-Book

An early, and persisting, business for the creation and sale of personalized children's books is Create-A-Book, 1478 College Parkway, Gulf Breeze, Fla. 32563.

Operator of the business Mr. Hefty has several United States patents, including U.S. Pat. No. 5,114,291. for a Method of making personalized children's storybook. This method generally pertains to the making a book, and more particularly pertains to the making a personalized children's storybook using a computer to form text pages having pre-stored, non-variable text merged with personalized, variable text to create an individualized story line. The method of the invention utilizes a personal computer and a laser printer to make text pages for a personalized children's storybook. The text pages include non-variable text and variable text. The non-variable text comprises general information which does not change or vary from book to book of the same title. The variable text comprises specific information which changes or varies for each book depending on the recipient of the book.

Mr, Hefty also has U.S. Pat. Nos. 5,190,316, 5,454,678 and 5,636,957, all concerning a Method of making personalized children's storybook utilizing stickers wherein a personalized children's storybook is made using preprinted books and inserting stickers containing personalized, variable text to create an individualized story line.

(Mr. Hefty also has yet a further a U.S. Pat. No. 5,915,904 for a Binding device used for crimping or deforming a U-shaped channel around a plurality of sheets of paper comprises a stationary crimping bar and a rotatable crimping bar rotatable coupled above the stationary crimping bar. This binding device is perceived to be useful in the creation of personalized children's books.)

2.3.2 Best Personalized Books

Another U.S. business that is, circa 2005, delivering personalized products for children is Best Personalized Books, Best Plaza, 4201 Airborn Drive, Addison, Tex. 75001. Best Personalized Books sells, as well as personalized children's books, products called Best Personalized Cards, Names Expressions™, Invitation Stationery, Personalized Clocks, Creative Expressions, Family Name Origins, Birthday Chronicle. Pet Pedigree, and Birthday Chronicle

This business is the assignee of U.S. Pat. No. 5,213,461 to Kalisher for a Method for rapidly generating personalized books while a purchaser waits. This patented method relates generally to the creation of books or documents and, more particularly, to a process for rapidly generating personalized books while a purchaser waits. In carrying out the method of the present invention, a series of steps is performed that includes loading a program having a predetermined story stored therein into a computer, entering personalized data into the computer to create a personalized story therefrom, feeding into a printing device a set of sheets having a first and second side, printing the personalized story on one of the sides of the sheets, separating the sheets transversely into pages, assembling the pages in a predetermined order and the fastening the assembled pages to a book jacket to form a personalized book. The sheets used in the disclosed method are preferably standard size, coated paper and have a partially preprinted design or illustration that partially covers the top side of each sheet, leaving blank areas for the story text, and fully covers the bottom side of the sheets.

Best Personalized Books is the further assignee of U.S. Pat. No. 5,524,932 to Kalisher for Sticker-based methods of making a personalized children's storybook. These patented methods concern the making a personalized children's storybook using preprinted books with textually blank areas on various ones of their pages, and adhering transparent stickers with personalized text thereon to the textually blank page areas to create a personalized story line in the book

Best Personalized Books is the further assignee U.S. Pat. No. 6,174,120 to Kalisher for an Apparatus for affixing book pages to a book cover and process for making same. This patented apparatus and method concerns affixing book pages to a book cover by use of a sheet of paper with at least one waxy side and two stickers, each having a first side, the first side being sticky and removably affixed to the waxy side of the sheet of paper. In the preferred embodiment, the two stickers are separated by a distance to accommodate the thickness of pages of a book. The apparatus also has a means for easy removal of the stickers from said sheet and is preferably done by having the sheet of paper extending beyond each of the stickers to allow for easy separation of the stickers from the sheet of paper. The stickers may be attached to the book pages by a variety of means such as staples, channel binding, or otherwise. The method includes the steps of aligning one or more stickers removably attached to a sheet of paper with pages of a book, affixing the stickers to the book pages, removing at least part of the sheet of paper from the sticker, and attaching the sticker to an inside cover of a book. A preferred embodiment includes affixing the stickers to the book pages by stapling, U-shaped channel binding, or otherwise.

2.4.3 Created 4 Me

Yet another business providing personalized children's books circa 2005 is Created 4 Me, P.O. Box 11360, Boulder, Colo. 80301. Once an order is received, including through a web site, Created 4 me creates a book around the specific name that the purchaser provides.

Created 4 Me alleges to uniquely personal a book with the provided child's name, making the child the “star of the show” in a product called “My Name in Lights.” In this product children are allegedly treated to a whimsical theatrical performance where their name is spelled out by delightful alphabet characters. Each 8½″×11″ professionally-bound hardcover book is unique and is created around a child's first, middle and last name. The last page of each My Name in Lights book includes the entire whimsical Cast of Characters alphabet. Also included is a dedication page where the purchaser has the option of including the child's birth date and a special message. Any name can be accommodated, whether it's Ashley Madison Smith or Cameron Jacob Grant Phillips.

One-of-a-kind books are created featuring the letters from a child's first, middle and last names. No two are alike. Alphabet characters spell out the name and help children learn simple words that begin with each letter. My Name in Lights is sold as a personalized gift for baby, birthday or holiday. It's claimed that children learn from and treasure such a gift as a keepsake because it was created for them with love

2.4.4 MYCD Story

MYCD Incorporated, 245 Park Avenue, 39th Floor, New York, N.Y. 10167, produces, circa 2005, a range of personalized interactive story books on PC CD-ROM where a particular named child becomes the Star of the adventure.

MYCD claimed that their stories uniquely “grow with the child”. Giving three levels of story, each CD develops the learning ability of the child and is packed with interactive fun and animation.

Each CD story book contains the child's full name, age, home-town, two friends names, an adult, a two-line dedication and the name of the giver, making this a truly personalized product! The child's full name is in accordance with any spelling chosen, and is not limited by a database. The child's age and home-town are featured. Two named friends appear, building the friendship aspect of the story. An adult to appear in the story, promoting child safety. According to all details that appear throughout the story, the book becomes a truly personal adventure the child.

CDs also feature a welcome screen showing a personal message from the giver, including their name.

Each story has fully interactive animated pages.

There are three difficulty levels to each story, allowing the story to grow with the child.

Also extra educational puzzles and games promote fun and learning.

The MYCD business is franchised to be run from a franchisee's home or operated in a retail environment, and is stated to be ideal for both full and part time options. The franchisee requires both a PC and a CD writer, which. if so chosen, can be transported to a retail site allowing the creation and sale instant personalized gifts for customers in just a few minutes. It takes only 2 minutes to make an Interactive CD.

The ‘while you wait’ concept is claimed to provide a number of retailing opportunities, as well as numerous home based opportunities to explore. The business is advanced as being flexible, where a retailer or franchisee can choose the marketing options that suit you best. Most people base their business at home, where overheads are minimized. There is always the possibility to take up a retail concession or site towards Christmas in order to maximize sales at this busy time of year.

It should be noted that MY CD STORY creates a non audio story that has text about a child, but no personalized graphics and no audio.

2.4.5 Kids Juke Box

Kids Juke Box, 5135 Avenida Encinas, Suite B, Carlsbad, Calif. 92008 furnishes a collection of personalized music for children. Personalized Music for children is claimed to make the ultimate gift that a child will love to listen to over and over again. Kids Juke Box has gathered a collection of music claimed to comprise the widest selection of customized CDs and names available.

Kids Juke Box CD's are stated to help a child feel loved and special. A child hears his or her name over and over again in a kids music CD. Each CD is compiled of 6 to 10 entertaining songs that mention the kid's name at least 40 times.

The child is claimed to build name recognition and self-esteem thru the upbeat music. From waking up in the morning right down thru to a bedtime lullaby, each song captures the child's attention and imagination. Everyone in the family can enjoy and even dance to the music.

2.4.6 Kids Story Book

Kids Story Book LLC, 5135 Avenida Encinas, Suite B, Carlsbad, Calif. 92008—assignee of the present invention—makes personalized, interactive, animated, audio CD story books for children. It is represented that (1) unlike any other personalized story book, Kids Story Book automatically reads the story to your child, and that (2) Kids Story Book offers a greater level of personalization than any other product.

When a Kids Story Book CD is ordered the purchaser chooses the child's name, race, gender, hair color, and eye color. Even parents who appear in the stories are also customized. With Kids Story Book the purchaser is stated get a truly personalized and exciting product that draws your child into the story and makes him or her the star of the show.

The vividly illustrated and animated scenes are claimed to be fun and interactive to an uncommon degree. Kids Story Book is alleged to keep a child reading and clicking with the kind of interest that can only be admired. Mere personalized paper books are stated not to compare favorably with Kids Story Book animation and personalization that “leaps off the page”.

Every Kids Story Book CD is an original story about a subject that is exciting for children. The stories are written for children aged 3-7. Each story has 15 or more vividly illustrated scenes with interactive animation and a maze to boot.

After the child hears the scene read to him or her, the child clicks on objects in the scene that either speak or move, and make sounds. This interaction draws the child further into the story and makes him or her feel part of the story, all the more so because the story is personalized with the child's name and customized with the child's gender, race, hair color and eye color.

The child is also able to click and make the narration repeat itself, or move to the next scene at the child's own pace. Every scene in the story has an icon to turn the narration on or off, allowing the child to read to himself or herself. Every scene also has a vocabulary icon that turns on the visual dictionary when the mouse glides over an object.

Kids story book is stated to be the only fully personalized interactive audio Story Book CD on the market. The computer reads the story to the child. The story enhances reading skills and includes vocabulary builder. The story is customized for gender, race, hair color, and eye color.

More than 2,000 boy and girl names are available circa 2005 and the list is growing. It is stated that if Kids Story Book does not have the name wanted, the purchaser should simply send the name needed. Periodically hundreds of new names are released based upon requests. This includes all names, all the time, regardless of how unusual they may be.

Each child can read at his or her own pace. Animation and interactive means fun. Every scene of every story can be printed for coloring. Every Story Book CD comes with a maze game with three levels. Stories are alleged to appeal to adults as well as children.

The Kids Story Books are stated to be the only Story Book CDs in the world that are personalized with your child's name and that further permit the purchaser to choose race, gender, hair color, and eye color. These chosen parameters are claimed to offer the most realistic and complete personalization experience possible, making that the child will literally see himself or herself as the star of the story.

At least some sales by Kids Story Book are presently, circa 2005, through distributors of the CDs. Goods are offered at wholesale. The Kids Juke Box system distributor system permits the distributor to create personalized CDs in under 2 minutes. A labeling program permits a distributor to customize the spelling of the name and add a personalized message (e.g., “To Julie with all our love, Mommy and Daddy).

In summary, Kids Juke Box products are claimed to “open the door for the happiness of children everywhere when they hear the beauty of personalized music for kids”.

2.5 Summary Motivation for the Present Invention

The present invention will momentarily be seen to be directed to producing personalized CD storybooks and music CDs on demand. Historically CD storybooks have normally been sold at a kiosk equipped with a Windows based computer and CD burner. A customer requests a story title for a particular child and gives the child's name, race, skin color, eye color, hair color and gender. All of these attributes are applied dynamically to the lead character in the animated and interactive story. The burn software application assembles these attributes along with the rest of the story artwork, sound files, and framework in order produce a custom personalized story for the child. The story is burned onto a CD and given to the customer. This whole process is performed by an attendant at the kiosk who enters the customer's information into the Story Book burn software.

The disadvantage of this model is that it requires a computer with a CD burner and an attendant to operate the software. It works great for kiosks, but most store owners are unable to accommodate a personal computer and an attendant standing by in order to sell the software.

### SUMMARY OF THE INVENTION

The present invention contemplates improvements in each of the time, place and manner by which digitalized music and stories sold for use by, most normally, a child is personalized with, inter alia, the name of the child so that music subsequently played to, or stories subsequently read to or by, the child contain personalized, name, references to the child.

Specifically, the present invention contemplates personalization of digitalized children's music and/or children's stories, most normally as are sold on digital media such as CDs and/or DVDs, at each of (1) a time and (2) a place that is permissively remote from the time and location of sale, and from the time and location of initial delivery of the digital media to the customer. Ultimate personalization is by (3) by a semi-automated method that specifically does not require any involvement by the seller at the time(s) or the location(s) of sale or delivery. According that the seller is no longer involved in personalization of children's music of children's stories to a particular, named, child, the seller may simply sell ubiquitous and universal musical and literary works on digital media nonetheless that the impact of these products on a particular child is enhanced by a subsequent personalization with, among other possibilities, the child's own name.

Still more specifically, the present invention contemplates that digitalized children's music and digitalized children's stories should be sold on digital media, normally CDs and DVDs, in accompaniment with, or with links upon the Internet to, both (1) personalization software and (2) personalization data. The (1) personalization software is exceedingly modest in scope, and is normally co-located upon the same media. It may alternatively, however, be downloaded and installed from a manufacturers site on the Internet. This personalization software, from wherever obtained, normally executes automatically upon initially inserting the digital media into a personal computer, and thereafter runs only until, and so long as, and at such times as its sole task—personalization of the digital media to a particular child—remains unfinished. Thereafter the software, which may still be present upon the digital media, is not normally exercised again, is most assuredly not automatically exercised again, and, indeed, will do nothing if attempted to be exercised on digital media that has already been personalized.

Meanwhile, the (2) personalization data can also be (2a) on the same digital media as are the music and/or stories (and most commonly also the modest software program), or (2b) on a companion media, such as another, second, CD or DVD, or (2c) on a server accessible on the Internet. Although option (2a) or, more commonly (2b) may be offered to purchasers who have no computerized access to the Internet, or may, indeed, be commonly packaged with the music and story media as a “default” option, the voluminous nature of the cumulative personalization data relevant to all children's names and/or other circumstances, combined, strongly mitigates that the totality of this data be held in a powerful, Internet-connected, computer at the manufacturer. In this case the purchaser's computer runs the (1) personalization program simply to identify to the manufacturer's computer (A) just what individual-type music and/or story media (out of many different such media) is presently being personalized, and, in response to questions, (B) what answers the user is providing as to the child's name and/or circumstances. The program running on the manufacturer's computer assembles from data pertinent to literally thousands of different children's names (or even builds from low-level source data in extreme cases) that particular data relevant to personalizing the individual-type media for this particular child. For example, the manufacturer's computer assembles such “sound bites” as do, most commonly, sing the child's name and/or something specific thereto (such as gender), and likewise assembles the particular sentences and/or phrases as are pertinent to personalize the stories that are upon the individual-type media.

Everything pertinent to personalize the individual-type media to the particular child is sent upon the Internet by the manufacturer's computer to the purchaser's computer as the complete (2) personalization data. It is there used by the (1) personalization program to “complete” the media, usually by permanently and irreversibly writing it to a new state where it is forever after personalized to the particular child. Still further personalized information, such as text and/or graphics suitable for a cover and/or label for the digital media (the CD or DVD) personalized with the particular child's name may additionally be sent from the manufacturer to the purchaser. Note that the total amount of personalization information communicated in each direction is modest, and suitable for even (1) a limited-bandwidth, dial-up, Internet connection and/or (2) slower user computer. In the event that the purchaser cannot write the digital media upon which the music and/or stories are initially sold and delivered, it is generally possible even to write the personalization information to a floppy disk or the like. Note in this regard that, in accordance with the well-known capability of computers to obtain digital files and records that are not in linear sequential order, the personalization information need not be envisioned as being “inserted” into the music and/or story (text) files. Indeed, it is much more likely to be written, as separate records, to the end of a CD or DVD. (In accordance with the industry standards for these media, this supplemental “second” recording session “hides”, but does not alter, the originally-recorded information. Appropriate software can still easily and normally retrieve this information—witness the many programs for recovering “lost” data from CDs or DVDs.).

1. A Digital Media Content Personalizing Method

Accordingly, in one of its aspects the present invention is embodied in a digital media content personalizing method.

Particularly, the method serves to personalize content of interest to children recorded on digital media with at least one selected proper name, therein personalizing said content to a particular child possessing the selected proper name.

The method includes (1) selling and delivering to a purchaser digital media in which is contained content of interest to a children, and also (2) delivering to the purchaser a personalization computer program executable in receipt of some particular proper name so as to modify the digital media to, upon subsequent use of its content, invoke a particular proper name, therein personalizing this subsequent use of the content of the digital media to the particular proper name.

The method continues with (3) executing, on a computer of the purchaser in which is present both the digital media and the delivered computer program, the computer program in respect of a particular proper name that is both selected and entered into the computer and into its executing program by the purchaser, so as to personalize the digital medial so that all subsequent use of its content will invoke the particular selected and entered proper name.

By these steps use of the content of the digital media subsequent to the purchaser's executing of the digital program on the computer of the purchaser is personalized in respect of the selected and entered proper name.

The delivering may in particular be of a personalization computer program executable to permanently modify the digital media. In this case the executing of the computer program permanently personalizes the digital media, and subsequent use of the content of the digital media is permanently personalized in respect of the selected and entered proper name.

The selling and delivering may particularly be of digital media in which is contained at least audio content of interest to children. In this case the delivering to the purchaser is of a personalization computer program that executable in receipt of some particular proper name so as to modify the digital media to, upon subsequent use of its content, invoke a particular proper name in at least the audio rendition of the media. Further in this case, the executing is so as to personalize the digital medial so that all subsequent use of at least its audio content will invoke the particular selected and entered proper name. Accordingly, use of the audio content of the digital media subsequent to the purchaser's executing of the digital program on the computer of the purchaser is personalized in respect of the selected and entered proper name.

The selling and delivering of the digital media to the purchaser may be contemporaneous with the delivering of the personalization computer program. This contemporaneous delivery of the personalization computer program may be because the personalization computer program is also recorded upon delivered digital media, may possibly be because the personalization program is contained is the selfsame delivered digital media upon which the content is also contained.

Alternatively, the delivery of the personalization computer program may be contemporaneous with delivery of the digital media because a link to where the personalization computer program may be downloaded upon the Internet accompanies the digital media. In this case the link to where the personalization computer program may be downloaded upon the Internet is preferably unique to each copy of the personalization computer program. Most commonly, and easily for purchaser use, the link upon the Internet to where the personalization computer program may downloaded upon the Internet is contained within digital media.

Further in the basic method, the delivering to the purchaser may be of, as well as the personalization computer program, a database of content relative to each of multiplicity of proper names. In this case the executing is further in a computer in which is accessible the database of content relative to each of the multiplicity of proper names, and is further in respect of a particular proper name selected from the multiplicity of proper names of the database as well as being entered into the computer and its executing program. By these steps subsequent playback of the digital media is personalized to the proper name selected from among the multiplicity proper names of the database.

When so contemporaneously delivering the database of content relative to each of the multiplicity of proper names, this content may be contained upon (1) the selfsame digital media as is the content, upon (2) other accompanying media, or (3) retrieved via a furnished link to a location upon the Internet to where download of data relative to at least one proper name may be had. Note that when this link accompanies the digital media, delivery of the database is considered contemporaneous (as was it when delivered on digital media) even though, in practice, it may take some additional minutes to access and download on the Internet.

In practice this internet link (to the proper-name-related database may be contained within digital media other than, additional to, and/or supplemental to, that digital media upon which is contained either the content, the personalization computer program, or both the content and the personalization computer program. And this is also true for the personalization program itself! It may this be seen that there are many, and versatile, ways of supplying the purchaser with all software and proper-name-related data necessary to effect personalization of the contents of the digital media.

2. A Method of Rendering Personalized Audio to a Child

In another of its aspects, the present invention may be considered to be embodied in a method of rendering to a particular child audio that is personalized with at least the child's proper name.

This personalized audio content rendering method includes first-delivering to a purchaser one or more digital media in which is contained at least audio content of interest to children. This audio content is not at time of delivery personalized to the name of any one child.

Second-delivered to the purchaser is a personalization computer program executable in receipt of some particular selected child's proper name so as to modify the digital media to, upon subsequent use of its audio content, invoke the particular selected child's proper name. This program, when once executed, thus serves to personalize the subsequent use of the audio content of the digital media to this particular selected child's proper name.

A database containing a multiplicity of sound clips that are pertinent to a multiplicity of children's proper names is provided the purchaser.

The purchaser (or someone acting in his or her stead) then executes at a time or at a location or at both a time and a location that is remote from the first-delivering (but not necessarily the second-delivering!), the personalization computer program in respect of a particular selected child's proper name so as to, with and by access to both the digital media and to sound clips from the database pertinent to the selected child's name, modify the digital media. According to this modification subsequent use of, at least, the audio content of the digital media will be personalized to the particular selected child's proper name. The method completes by, and with, rendering from the modified digital media audio that is personalized with at least the child's proper name.

The first-delivering may be contemporaneous with the second-delivering, with the personalization computer program as well as the audio content of interest to children being delivered on digital media. In this case the providing of the database to the purchaser may also be by digital media, and this may be (but is not mandated to be) contemporaneous with the second-delivering and the first-delivering.

Alternatively, 19. the providing of the personalization computer program to the purchaser may transpire via the Internet. In this eventuality also, the providing of the database to the purchaser is by digital media (as was the first-delivering of audio content of interest to children).

3. A Special Self-Altering and Self-Personalizing Digital Media

In still yet another of its aspects the present invention is embodied in a digital medium interactive with (1) a computer and (2) a computer operator selecting a (3) child's proper name from (4) a database of content particularized to a multiplicity of children's proper names, so as to be both (A) self-altering, and (B) personalizing of its own content;

This digital medium contains contents of interest to children, this content initially being without personalization to the proper name of any one child.

It further contains a program executable on a computer (1) to receive from an operator of the computer a selected child's name and, in respect thereof, reference a database of content particularized to children's proper names so as to retrieve content relative to the selected particular child's name, and (2) to write this retrieved content onto the selfsame digital media so that it will be retrieved along with the contents of interest to a child upon playback of the digital media, and will produce upon this playback an output personalized to the child.

Thus the selfsame digital medium contains both (1) content, and (2) a program executable to, by reference to a database, supplement this content. This digital medium is, after execution of the program it contains, personalized to the selected child's name.

The digital medium may further contain the database. In this eventuality each of the contents of interest to children, and program executable to personalize the digital medium, and the database are each, and all, on digital media.

The contents of interest to children contained within the digital medium may, and preferably do, include at least audio content.

The execution of the program for personalization of the contents of the digital medium is preferably performed but one time only, to personalize the content with but one single selected child's name

The digital medium is most commonly an optical disk, most normally a CD or DVD.

4 Summary

Thus, in summary, the present invention permits a parent or other person at a personal computer to, in a one-time once-only operation, initialize (by supplementary writing) the digital media to the name and/or other information of a particular child, whereupon the digital media will thereafter permanently unchangeably play children's music and/or stories, or produce readable stories on a computer monitor or a printer or the like. This personalization is clearly commonly done at a time and a place remote from initial delivery of the digital medium to the purchaser. The store, or seller, is no longer required to personalize digitalized music, stories and the like for to a child at, or before, time of delivery.

### BRIEF DESCRIPTION OF THE DRAWINGS

Referring particularly to the drawings for the purpose of illustration only and not to limit the scope of the invention in any way, these illustrations follow:

FIG. 1 is a schematic block diagram of one preferred system of the present invention.

FIGS. 2a and 2b are a Table 1 showing the business process of Story Installation with Internet Connection in accordance with the present invention.

FIGS. 3a and 3b are a Table 2 showing the business process of Story Installation without Internet Connection in accordance with the present invention.

FIGS. 4a and 4b are a Table 4 showing the business process of Manage Languages in accordance with the present invention.

FIGS. 5a and 5b are a Table 5 showing the business process of Manage Stories in accordance with the present invention.

FIGS. 6a and 6b are a Table 6 showing the business process of Manage Kids Names in accordance with the present invention.

FIG. 7 is a Table 7 showing the business process of Map Kids Names Between Languages in accordance with the present invention.

FIG. 8 is a Table 8 showing the business process of Associate Spellings to Kids Names in accordance with the present invention.

FIG. 9 is a Table 9 showing the business process of Manage Application Parameters in accordance with the present invention.

FIGS. 10a and 10b are a Table 10 showing the business process of Manage CD Serial Numbers in accordance with the present invention.

FIG. 11 is a Table 11 showing the business process of List Requested Kids Names in accordance with the present invention.

FIGS. 12a and 12b are a Table 12 showing the business process of Administrative Reports in accordance with the present invention.

FIGS. 13-23 are screen shots showing the interface presented to the purchaser by and with the Story Installation with Internet Connection in accordance with the present invention.

### DESCRIPTION OF THE PREFERRED EMBODIMENT

The following description is of the best mode presently contemplated for the carrying out of the invention. This description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

1. Demand for the Present Invention

1.1. Motivation for the Present Invention

The present invented was motivated by a desire to eliminate (1) the need of the store owner to dedicate a computer for producing personalized stories and music, and (2) the manpower involved in attending to the customer and computer. The assignee of the present invention calls the process of the invention “Grab and Go” because the customer can simply pick up an already burned generic CD and personalize the product at home. This means that the retail store owner can stock a story book CD just like any other CD product.

1.2 Demand for the Present Invention

Demand for personalized stories is expected to increase due to the following reasons:

Customers are now used to the Internet and expect to be able to customize the stories they buy without direct contact with one of the distributors;

he throughput of an Internet solution is much bigger that the face-to-face approach, at much lower costs.

A central database, directly accessed by the clients, is much easy to administer and eliminates the need to redistribute the newly recorded names to all distributors;

Multiple installations from a CD containing a story customized with a certain name must be limited.

The sales staff and administrators are not being supported with accurate and timely information about the profiles of the customers, what names are being required for customization, etc.

The present invention is directed to eliminating all these shortcomings of the current methods.

2. Personalized Music CDs

Personalizable, and personalized, digital media products in accordance with the present invention are particularly, and preferably, made and sold (1) as CDs, (2) containing music. Accordingly, they are commonly called “Music CDs”. The following explanation will thus concentrate on this embodiment, although textual and video applications are commensurate, and equivalent.

The personalized music CD permits the child's personal information to be inserted into a prerecorded song. And thereafter sung live. This may be realized by directly “patching” the audio, or encoded audio, files. Alternatively, a child's name may be created upon initial input using text to speech technology (TTS) and only then inserted into a prerecorded song

The personalized music CD is preferably sold in retail locations. It is an actual CD that is inserted into a computer and is then, most preferably, used to access a pre-determined web site of the manufacturer. Most preferably ensuing interaction (as directed by the personalization software) with this web site creates the personalized CD. Alternatively, the entire product may be sold directly and completely off a web site.

The customer must normally log in using unique personal information. Only then can a personalized CD be first created on line, and then downloaded to the purchaser's computer for direct burning as a CD. Although this “all-Internet” process is operationally expedient, it does require (1) download or voluminous content data by the purchaser, and (2) skills (if not also software) permitting the purchaser to create the CD.

Thus the presently preferably scenario for application of the present invention remains that a CD should be sold with the prerecorded music on it. However the name data is then preferably downloaded from the primary web site (or a secondary music program web site).

If this name data instead accompanies the content CD upon initial sale and delivery, it is normally so extensive as to require a second CD. Of course, in this situation there is no need for purchaser Internet connectivity, and no need to ever go online.

The personalization program either provided from the web site or, preferably, delivered with the content disk, serves to inserts the child's personal information like name or age etc. into the song into predetermined places, creating a song that is now complete and includes the child's information.

This new song is now downloaded and stored on the child's computer and is then able to be burned to a CD for use in any audio device that plays music CD's.

The included software—either as is deliverable on digital media or via the Internet—may include CD burning software needed to burn a CD in the event a purchaser's computer does not have the software to burn a CD but does have a CD burner.

The preferred program also provides a template of a CD label that the customer can use to create a personalized label that would be attached to the CD. This label may be like a sticker, or may be printed directly onto the CD using a CD printer.

3. Interactive CD ROM Story Books

The present invention is also embodied in CD ROM Story Books.

This embodiment of the invention is manufactured to be sold as a personalized and Interactive Audio CD Story Book or game. Here a CD would be sold in a retail location, on line or any other location where products are sold, containing a program that can be used to create the main character(s) of the story or game. Commonly a series of scenes that contain text and graphics can be altered depending on the information provided by the customer. The customer must insert the CD into a computer and access the program using the single use access code provided with the CD. After the customer provides some required information they can begin to create the main characters of the story or game by changing the features like (Gender, Ethnicity, hair Color and Eye Color).

The purchaser commonly also inputs other personal information about the child to create the personalized story. The personal information would be downloaded into the program using a web site or a second program provided. The character(s) which were created by the customer would then be inserted into the story and the text of the story would be created using the prerecorded text and the personalized information provided by the customer. Creating a CD that reads a story to the child including the information provided in the storyline and the main characters on the screen represent the physical characteristics selected by the customer. The text is read using human voices which were prerecorded and stored as audio files or Text-to-Speech (TTS) technology.

The actual CD Story Book or game is inserted into a computer and used to access a web site, and then allowing them to create the personalized text and characters. OR the product is sold directly off a web site where the customer must log in using their personal information and then they can create the CD on line and then down load it to their computer or burn directly to a CD. (if all goes well people will just log onto our site to make their own CD without needing to go t the store and buy a CD first)

The CD is sold with the prerecorded story, text and graphics on it however the name or other personal information, physical characteristics of the top characters must be downloaded from a web site or created using a secondary program. (some day we may offer a 2 CD set, where they don't need to go online)

The program from the web site or provided software disk inserts the child's personal information like name or age etc. into the story into predetermined places, creating a story that is now complete and includes the child's information. It also inserts the characters that were created by the user into the graphics in predetermined places. The user will see the characters they have created, read the text of the story that includes their personal information and hear the text read aloud by a human or TTS that includes their personal information (I use the term information, incase we ever use the TTS we can insert several variables)

This new story is now downloaded and stored on the customer's computer or the original CD.

The preferred program also provides, as before, a template of a CD label that the customer can use to create a personalized label that would be attached to the CD like a sticker or printed directly onto the CD using a CD printer.

4. Personalized Activity Books

The present invention is still further susceptible of being embodied in personalized activity books. Activity books are defined as books where the child must use his or her hands, as well as eyes, to perform the “exercises” of the book.

5. Basic Features of the Present Invention

5.1 Basic Features of a Storybook CD in Accordance with the Present Invention

The basic features of a storybook CD in accordance with the present invention are as follows:

First, an installation wizard collects child's name and opens a Web service in order to automatically download the audio file of that child's name from an online database.

Second, the installation wizard allows child to choose his or her personal attributes from visual cues: including gender, eye color, skin color, face type, hair color, and hair style.

Third, the installation wizard copies story book framework, artwork, sound files and all related files from CD.

Fourth, the installation wizard assembles the story book elements from step 3 along with the child's name file in step 1 and attributes in step 2 in order to compile the final story book application on the computer hard disk drive.

Fifth, the installation wizard collects a serial number that the customer enters from a sticker on the CD jewel case. This serial number is uploaded to the online database and ensures that the CD is not used illegally to build story books for more than one child.

5.2 Basic Features of a Music CD in Accordance with the Present Invention

The basic features of a music CD in accordance with the present invention are as follows:

First, the installation wizard collects child's name and opens a Web service in order to automatically download the audio file of that child's name from an online database.

Second, the installation wizard copies instrumental track and voice track of songs from CD to hard disk drive. These songs are complete except that they are missing phrases from the voice track that include the kid's name and a word or two before and after.

Third, the installation wizard mixes the song with the downloaded kid name in order to produce a personalized song for a particular child.

Fourth, a customized CD burn application is included for burning the child's songs to a blank CD.

5.3 Basic Process for Making Music Files Used in the Present Invention

A description of the preferred process for making the music files is as follows:

First, a musician or musicians record the instrumental track.

Second, a musician records voice track on top of instrumental track but omits phrases that includes the kid name. A phrase is one or two words before and after kid name.

The result of steps 1 and 2 is a single musical file that goes onto a CD.

Third, a musician listens to instrumental track in his earphones and records voice track of phrases that include kid name. This becomes a small file.

Fourth, the steps 1) through 3) are repeated for each kid phrase in song that is different.

The result of steps 3 and 4 is a database of kid name phrases that we put in an online database.

Now the customer inserts a CD in the computer and we load our own program that will download the kid name phrases and mix it with the song on the CD.

6 Architecture of the Present Invention

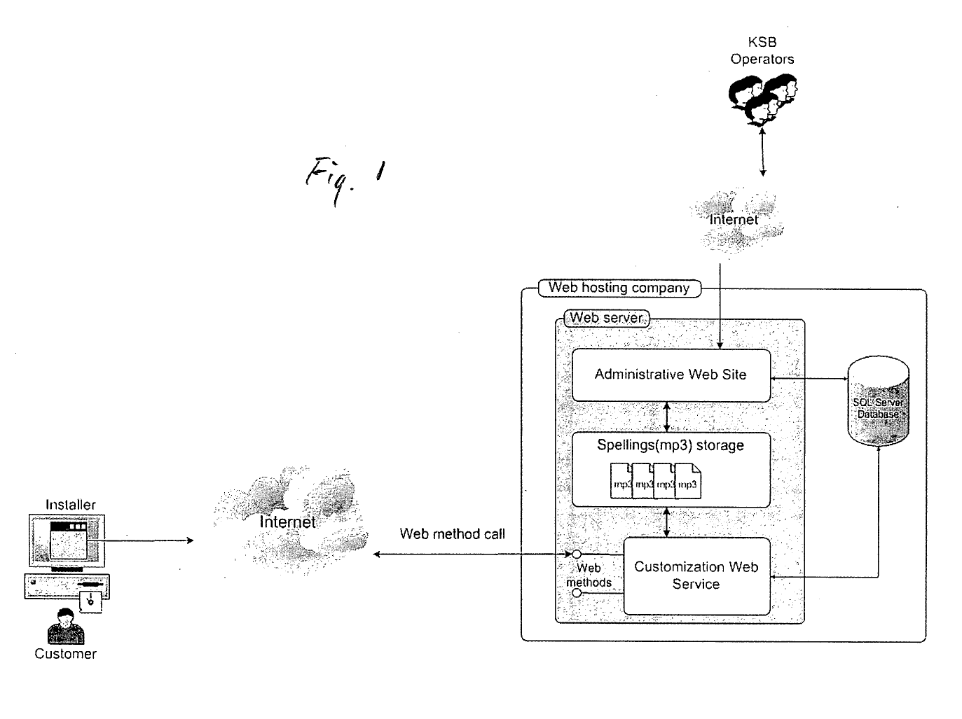

A schematic block diagram of one preferred system of the present invention is shown in FIG. 1.

In this and in following Figures “KSB” stands for “Kids Story Book” and, when applied to the word “operators” as in “KSB operators”, means those human individuals representing the manufacturer that in part operate the system. The other system “operative” is the “Customer”.

6.1 Online Database

An Online Database is maintained.

It first provides ability to upload new kid names individually to online database Second, ability to reissue a kid name in case of bad pronunciation, customer mistake, new computer, etc. is provided.

Third must maintain database of all customers

Fourth, the Internet activation process should ensure that someone hasn't used the same CD to install a story on two different computers.

6.2. Design Goals and Constraints

6.2.1 Performance

Processor utilization does not exceed 80 percent during spikes of 100 concurrent users (running the installer for the story).

6.2.3 Availability

Because the customization/personalization web service is accessed by customers across the world, it needs to be available 24 hours a day, 7 days a week.

The administration Web Site is accessed by the Manufacturer's operators, it needs to be available during their business hours.

6.2.4 Reliability

Because of the need for 24*7 availability, automatic failover will be required. In addition, disaster recovery and backup plans and procedures must be created.

6.2.5 Scalability

The system supports an average load of 100 concurrent users (running the installer for the story). In 2005, and this is expected to grow by 10 percent each year for the next three years.

6.2.6 Security

The sensitive information (recorded names) will be encrypted while being transferred over the Internet and will not be stored on the client computer until a successful installation. Authentication on the Administration Web Site will be done using .Net Forms Authentication over SSL (server certificate).

6.2.7 Interoperability

There are no requirements for interoperability with other systems.

6.2.8 Location

The Administration Web Site will be located at a hosting provider and will be accessed by the Manufacturer's operators using Internet Explorer 5.5 and above.

The Customization Web Service will be used by customers using a range of Windows operating systems in a variety of locations around the world.

3.8 Internationalization

The story installer needs to support international character sets and date/time formats.

6.2.9 Setup/Installation

The Customization Web Service and Administration Web Site will be installed at a hosting provider.

A migration of the current names database and sound file into the new system will be done.

6.2.10 Assumptions and Constraints

The installer of the story will run on Windows 98 SE and above.

The Customization Web Service and Administration Web Site will run on Windows 2000 Server or Windows 2003 Server, using .NET Framework 1.1. They will both be using the names database running on Sql Server 2000 Standard or Enterprise Edition.

7 Features and Functionality

The software of the invention consists of two main modules:

The Story Installer which, in turn, consists of the actual Windows Installer and the Web Service that facilitates its access to the customization database; and

the Administrative Web Site which allows the KSB operators to manage recorded names and CD serial numbers.

7.1 Story Installer

7.1.1 Install Using an Internet Connection

This function will allow the customer to install and customize the story using the Customization Web Service over an Internet Connection.

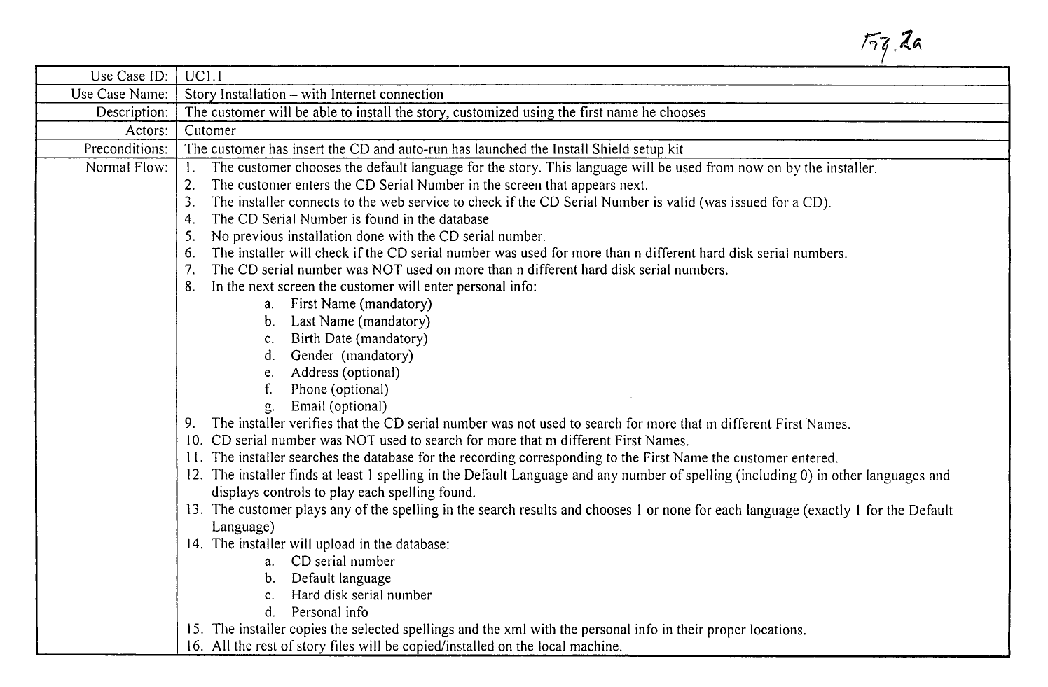

The business process usage scenario is described in Use Case UC1.1—Story Installation with Internet connection is shown in Table 2 of FIG. 2, consisting of FIGS. 2a and 2b.

The number of searches per CD serial number is limited. In the database we are going to store, for every CD serial number, a list of distinct First Names that were searched for. This list will be a global one, no metter how many times the user installed the product. Whenever the user searches for a name, if the search returned any spellings, the name is inserted in the database for that serial number.

If the size of this list reaches the value of the application parameter that specifies the maximum number of distinct names the user can search for, then the user cannot search for other names so he can not install the product using a name that is not in the list. Before every search, after the Personal Info screen, the user is warned that, if he goes on with the search, he will be able to do just n more searches. Also, a list of names he previously searched for is displayed.

7.1.2 Install Using a Customization CD

This function will allow the customer to install and customize the story using the CD he received after providing the personal info to the Manufacturer's operators.

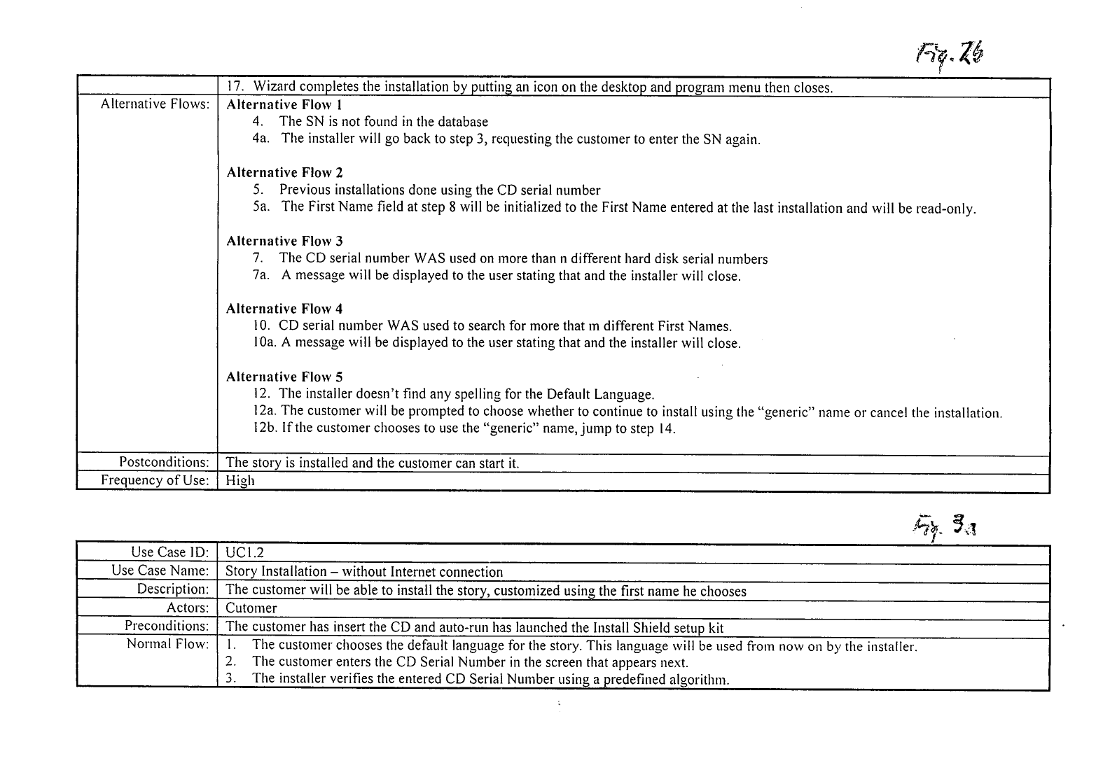

For the business Process the usage scenario is described in Use Case UC1.2—Story Installation without Internet connection, shown in Table 3 of FIG. 3, consisting of FIGS. 3a and 3b.

7.2 Administrative Web Site

7.2.1 Manage Languages

This function permits manufacturer's personnel—“Kids Story Book personnel”, or “KSB personnel”—to create, maintain, and delete languages supported by the whole application (all the stories). Managing the languages globally and then associating them to certain stories is necessary if reports involving aggregations on languages (like how many installations were done in English, for any story) are required.

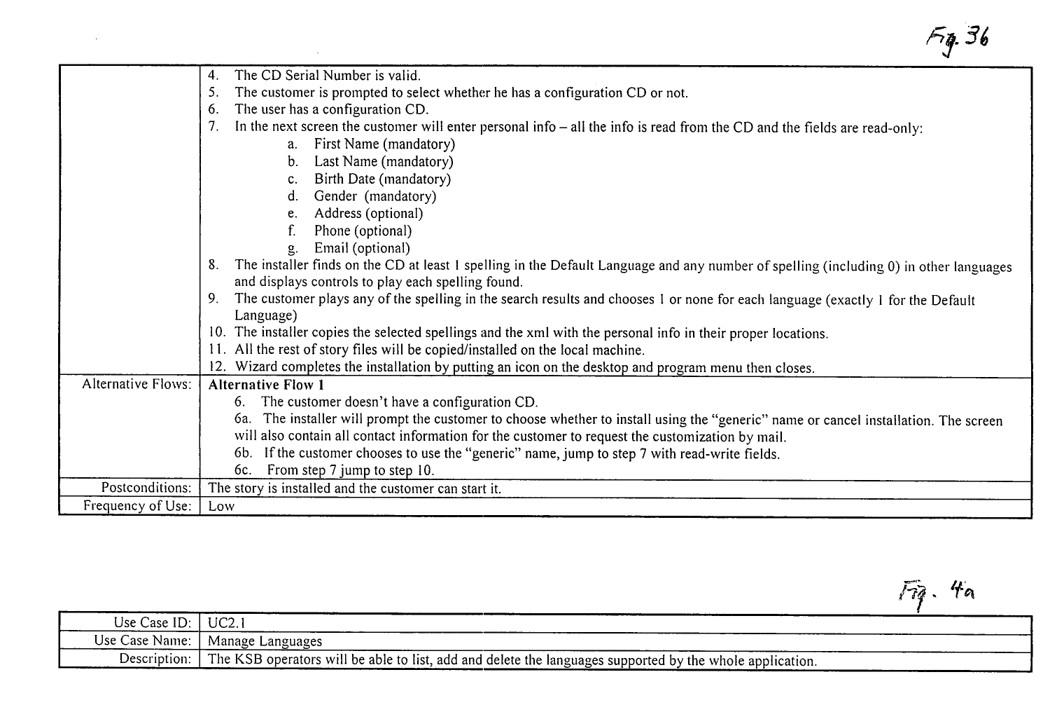

The business process usage scenario is described in Use Case UC2.1—Manage Languages. This process is shown in Table 4 of FIG. 4, consisting of FIGS. 4a and 4b.

7.2.2 Manage Stories

This function allows KSB operators to create, maintain, and delete information about stories.

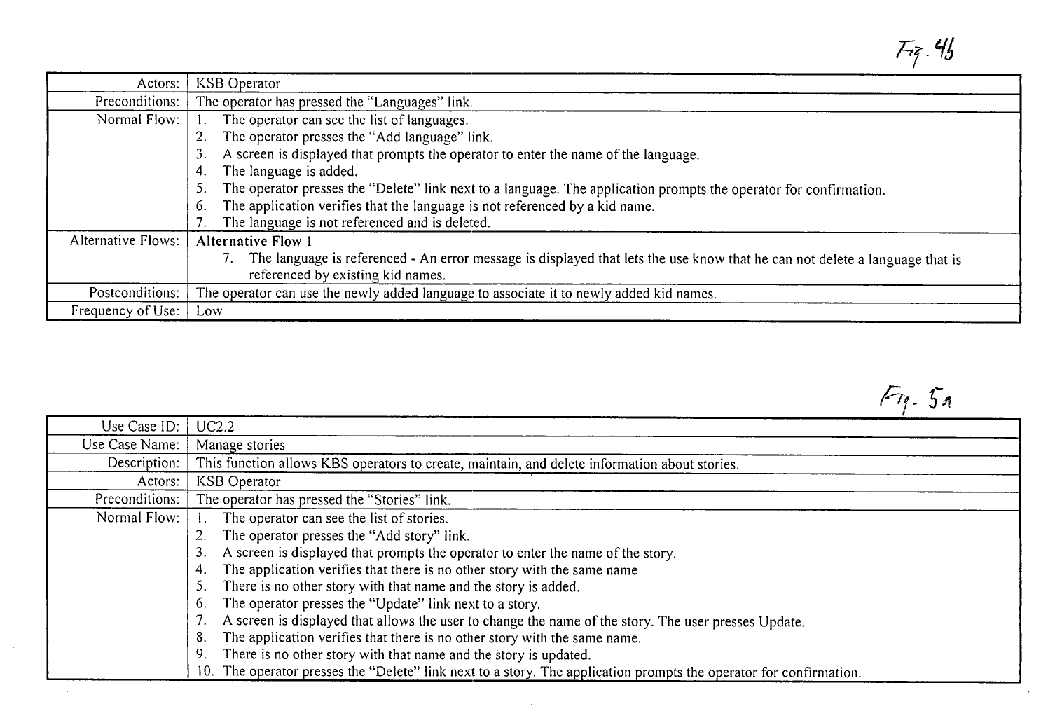

The business Process usage scenario is described in Use Case UC2.2—Manage Stories. This process is shown in Table 5 of FIG. 5, consisting of FIGS. 5a and 5b.

7.2.3 Manage Kid Names

This function allows KSB operators to manage kid names for a certain language (any story).

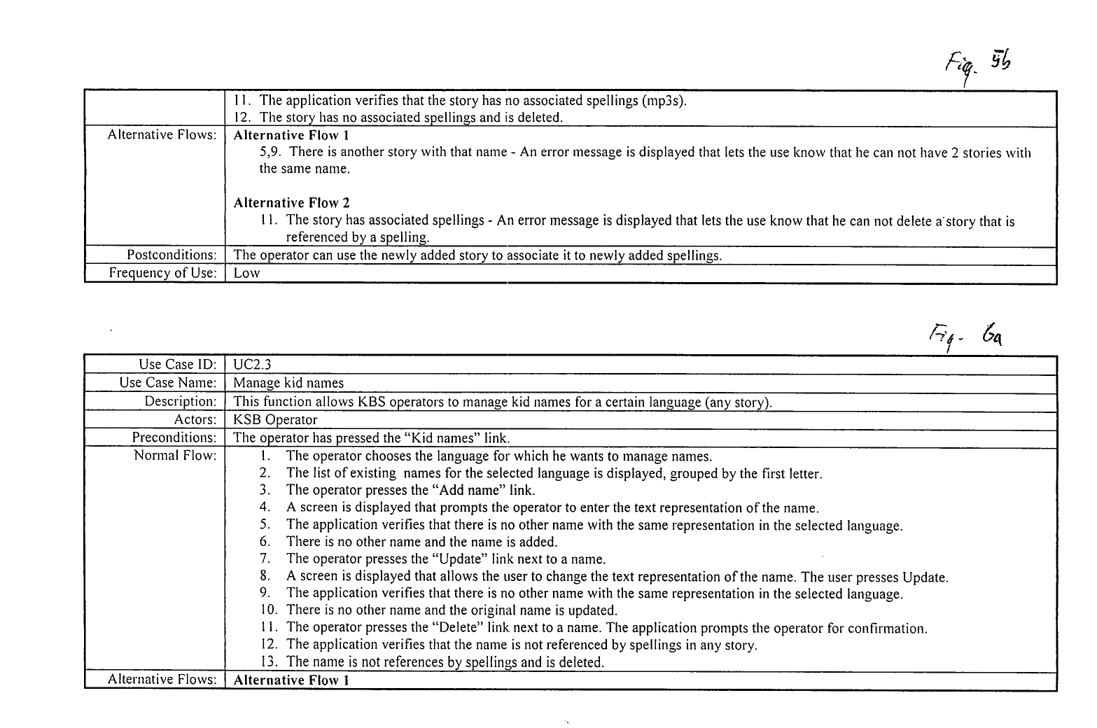

The business process usage scenario is described in Use Case UC2.3—Manage kid names. This process is shown in Table 6 of FIG. 6, consisting of FIGS. 6a and 6b.

7.2.4 Map Kid Names Between Languages

This function allows KSB operators to create a bidirectional map between names in different languages.

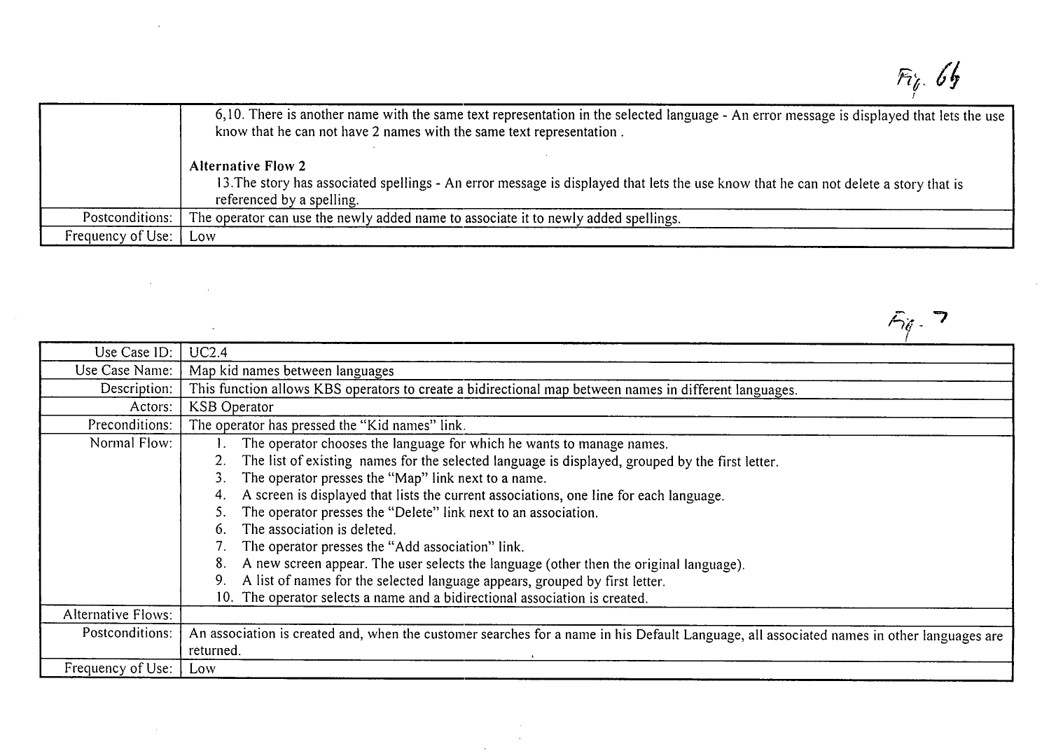

The business process usage scenario is described in Use Case UC2.4—Map kid names between languages. This process is shown in Table 7 of FIG. 7.

7.2.5 Associate Spellings (mp3) to Kid Names

This function allows KSB operators to associate (and disassociate) sound files to names and stories either by uploading them or selecting an already uploaded file.

The Business Process usage scenario is described in Use Case UC2.5—Associate spellings to kid names. This process is shown in Table 8 of FIG. 8.

7.2.6 Manage Application Parameters

This function allows KSB operators to manage parameters like:

the maximum number of times the customer can install the story on different hard disks.

The maximum number of times the customer can search for different kid names, etc;

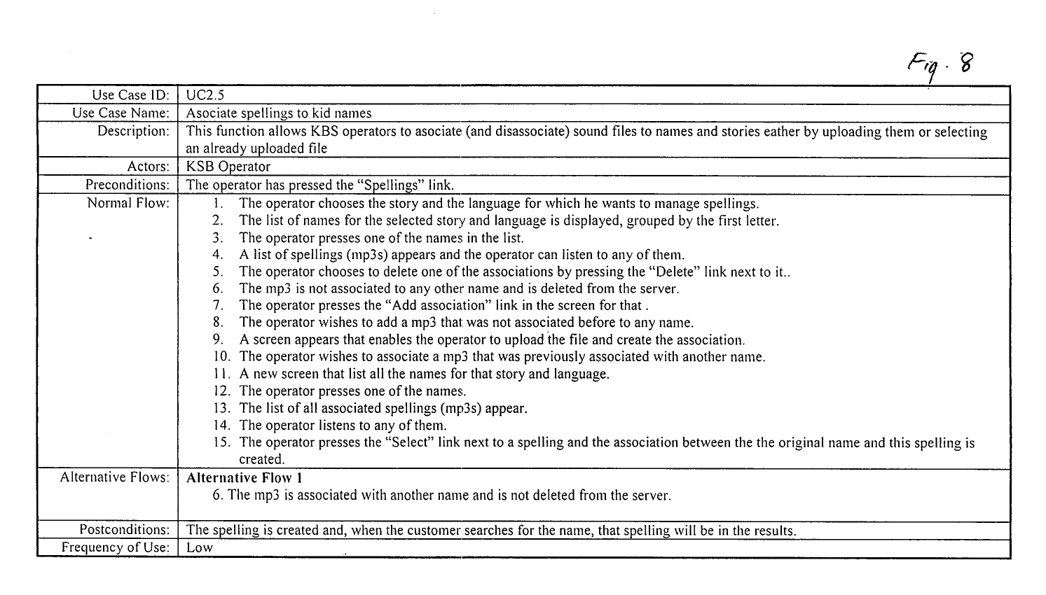

The business process usage scenario is described in Use Case UC2.5—Manage application parameters. This process is shown in Table 9 of FIG. 9.

7.2.7 Manage CD Serial Numbers

This function allows KSB operators to (1) list all generated CD serial numbers; (2) list only CD serial numbers that were used for an installation; (3) add valid generated CD serial numbers; and (4) lock/unlock/extend a specified CD Serial Number from further being downloaded its related audio kid names

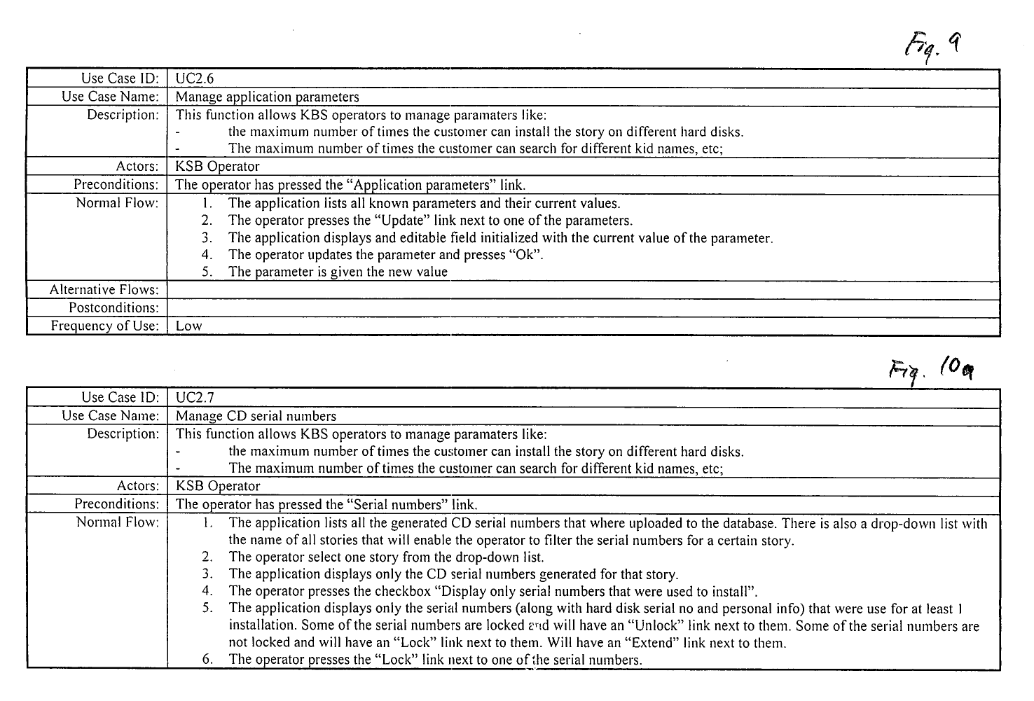

The business process usage scenario is described in Use Case UC2.7—Manage CD serial numbers. This process is shown in Table 10 of FIG. 10, consisting of FIGS. 10a and 10b.

7.2.8 List Requested Kid Names

This function allows KSB operators to review all the new orders from the new kid names reported that are not present in the database yet at the time the Installation Procedure was performed.

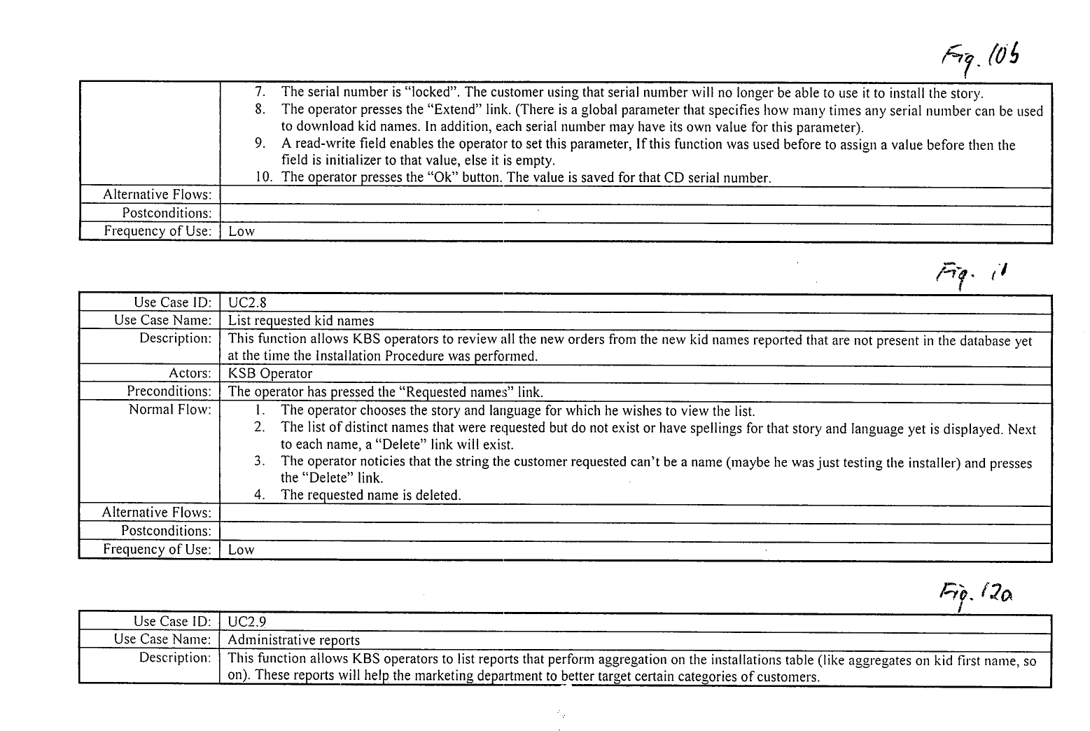

The business process usage scenario is described in Use Case UC2.8—List requested kid names. This process is shown in Table 11 of FIG. 11.

7.2.9 Administrative Reports

This function allows KSB operators to list reports that perform aggregation on the installations table (like aggregates on kid first name, so on). These reports will help the marketing department to better target certain categories of customers.

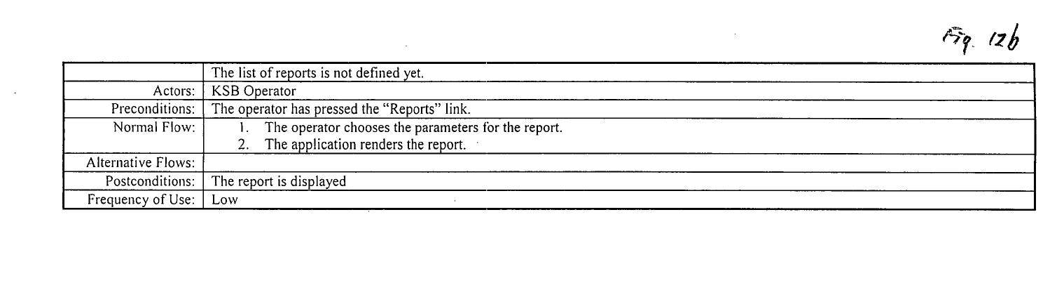

The business process usage scenario is described in Use Case UC2.9—Administrative reports. This process is shown in Table 12 of FIG. 12, consisting of FIGS. 12a and 12b.

8. Solution Architecture

8.1 Infrastructure

The server that hosts the Customization Web Service and the Administrative Web Site will have a 2.4 Ghz Intel Xeon Processor or equivalent. The operating system software will be Microsoft Windows 2003 Standard or above with the latest service pack. The database will be Microsoft SQL Server 2000, with the latest service pack.

8.2 Visual Design

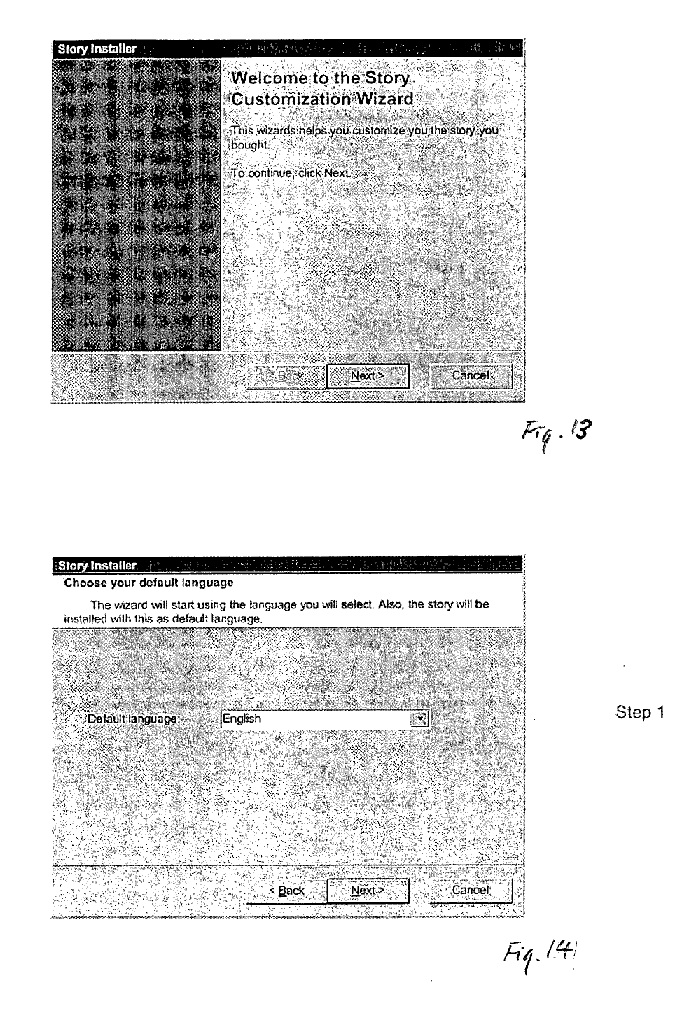

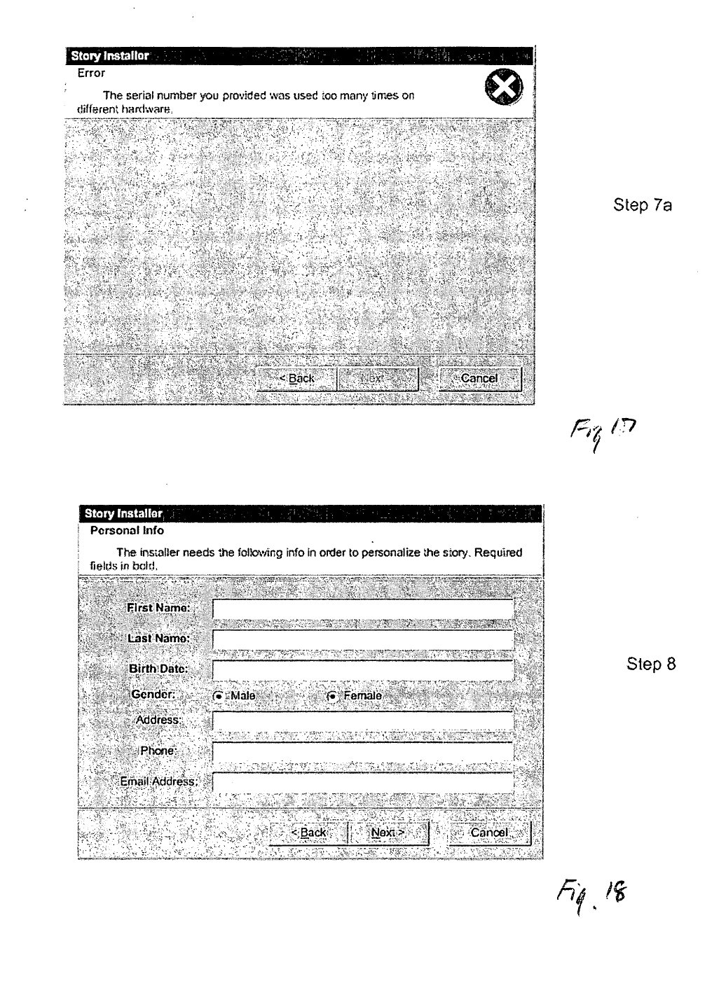

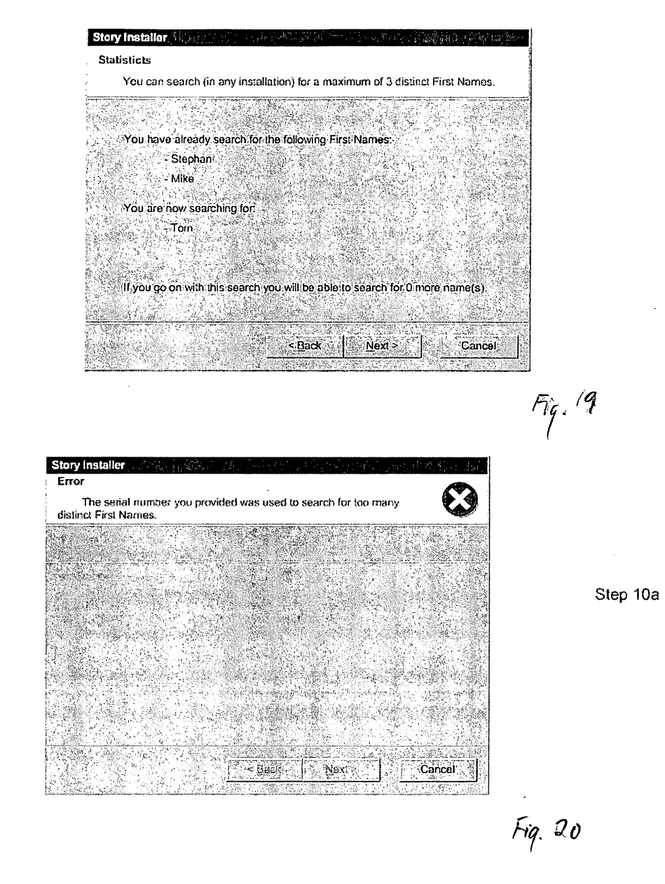

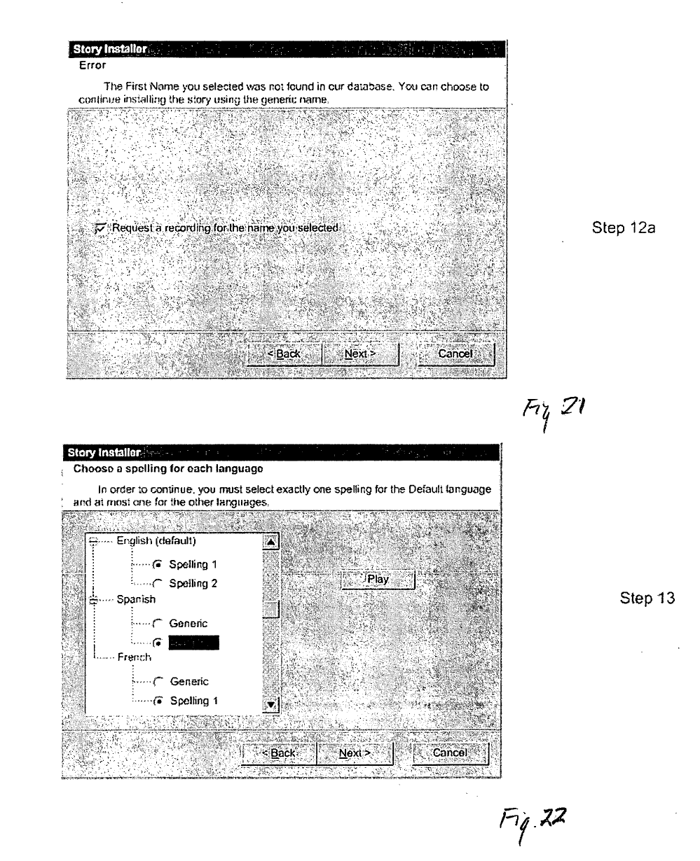

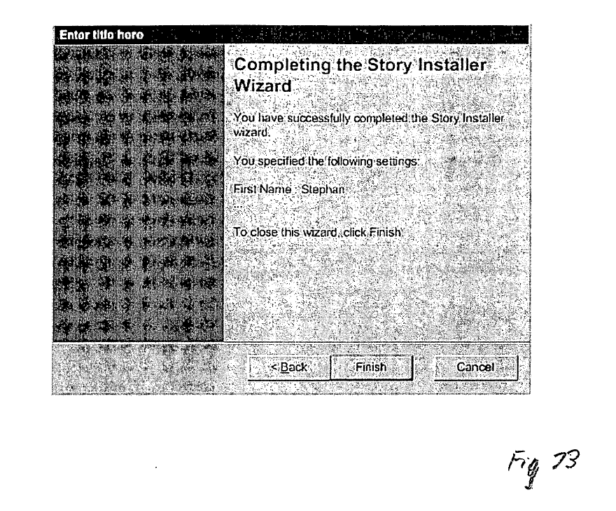

The visual design of the preferred system as seen by the Customer (see FIG. 1) is shown in the screen shots of FIGS. 13-23.

9. CONCLUSION

In accordance with the preceding explanation, variations and adaptations of the personalization system in accordance with the present invention will suggest themselves to a practitioner of the computer sciences.

For example, it is possible to use the system for personalization of content other than is (primarily) directed towards children.

For example, it is possible to personalize media obtained by other than purchase, such as by download from the Internet, and there need not be a one-to-one correspondence between the personalization program and the contents, and the media, ultimately personalized.

In accordance with these and other possible variations and adaptations of the present invention, the scope of the invention should be determined in accordance with the following claims, only, and not solely in accordance with that embodiment within which the invention has been taught.

What is claimed is:

1. A method of personalizing content of interest to children recorded on digital media with at least one selected proper name, therein personalizing said content to a particular child possessing the selected proper name, the method comprising:
selling and delivering to a purchaser digital media in which is contained content of interest to a children;
delivering to the purchaser a personalization computer program executable in receipt of some particular proper name so as to modify the digital media to, upon subsequent use of its content, invoke a particular proper name, therein personalizing this subsequent use of the content of the digital media to the particular proper name; and
executing, on a computer of the purchaser in which is present both the digital media and the delivered computer program, the computer program in respect of a particular proper name that is both selected and entered into the computer and into its executing program by the purchaser, so as to personalize the digital medial so that all subsequent use of its content will invoke the particular selected and entered proper name;
wherein use of the content of the digital media subsequent to the purchaser's executing of the digital program on the computer of the purchaser is personalized in respect of the selected and entered proper name.

2. The digital media content personalizing method according to claim 1
wherein the delivering is of a personalization computer program executable to permanently modify the digital media; and
wherein the executing is of the computer program to permanently personalize the digital media;
wherein the use of the content of the digital media is permanently personalized in respect of the selected and entered proper name/

3. The digital media content personalizing method according to claim 1
wherein the selling and delivering if of digital media in which is contained at least audio content of interest to children;
wherein the delivering to the purchaser is of a personalization computer program executable in receipt of some particular proper name so as to modify the digital media to, upon subsequent use of its content, invoke a particular proper name in at least the audio rendition of the media, therein personalizing this subsequent use of at least the audio content of the digital media to the particular proper name; and
wherein the executing is so as to personalize the digital medial so that all subsequent use of at least its audio content will invoke the particular selected and entered proper name;
wherein use of the audio content of the digital media subsequent to the purchaser's executing of the digital program on the computer of the purchaser is personalized in respect of the selected and entered proper name.

4. The digital media content personalizing method according to claim 1
wherein the selling and delivering of the digital media to the purchaser is contemporaneous with the delivering of the personalization computer program.

5. The digital media content personalizing method according to claim 4
wherein the delivery of the personalization computer program is contemporaneous with delivery of the digital media because the personalization computer program is also recorded upon delivered digital media.

6. The digital media content personalizing method according to claim 5
wherein the delivered digital media upon which the personalization program is contained is the selfsame delivered digital media upon which the content is also contained.

7. The digital media content personalizing method according to claim 4
wherein the delivery of the personalization computer program is contemporaneous with delivery of the digital media because a link to where the personalization computer program may be downloaded upon the Internet accompanies the digital media.

8. The digital media content personalizing method according to claim 7
wherein the link to where the personalization computer program may be downloaded upon the Internet is unique to each copy of the personalization computer program.

9. The digital media content personalizing method according to claim 7
wherein the link upon the Internet to where the personalization computer program may downloaded upon the Internet is contained within digital media.

10. The digital media content personalizing method according to claim 1
wherein the delivering to the purchaser is of, as well as the personalization computer program, a database of content relative to each of multiplicity of proper names; and
wherein the executing is further in a computer in which is accessible the database of content relative to each of the multiplicity of proper names, and is further in respect of a particular proper name selected from the multiplicity of proper names of the database as well as being entered into the computer and its executing program;
wherein subsequent playback of the digital media is personalized to the proper name selected from among the multiplicity proper names of the database.

11. The digital media content personalizing method according to claim 10
wherein the delivery of the database of content relative to each of the multiplicity of proper names contemporaneous with delivery of the digital media because the personalization computer program is contained upon the selfsame digital media.

12. The digital media content personalizing method according to claim 10
wherein the delivery of the database of content relative to each of the multiplicity of proper names contemporaneous with delivery of the digital media because a link to a location upon the Internet to where download of data relative to at least one proper name may be had accompanies the digital media.

14. The digital media personalizing method according to claim 10
wherein the link upon the Internet to where the personalization computer program may downloaded upon the Internet is contained within digital media other than, additional to, and supplemental to, that digital media upon which is contained either the content, the personalization computer program, or both the content and the personalization computer program.

15. A method of rendering to a particular child audio that is personalized with at least the child's proper name, the personalized audio content rendering method comprising:
first-delivering to a purchaser one or more digital media in which is contained at least audio content of interest to children, this audio content not being at time of delivery personalized to the name of any one child;
second-delivering to the purchaser a personalization computer program executable in receipt of some particular selected child's proper name so as to modify the digital media to, upon subsequent use of its audio content, invoke the particular selected child's proper name, therein personalizing this subsequent use of the audio content of the digital media to this particular selected child's proper name;
providing to the purchaser a database containing a multiplicity of sound clips that are pertinent to a multiplicity of children's proper names;
executing, at a time or at a location or at both a time and a location that is remote from the first-delivering, the personalization computer program in respect of a particular selected child's proper name so as to, with and by access to both the digital media and to sound clips from the database pertinent to the selected child's name, modify the digital media so that subsequent use of, at least, its audio content will be personalized to the particular selected child's proper name; and
rendering from the modified digital media audio that is personalized with at least the child's proper name.

16. The personalized audio content rendering method according to claim 15
wherein the first-delivering is contemporaneous with the second-delivering, with the personalization computer program as well as the audio content of interest to children being delivered on digital media.

17. The personalized audio content rendering method according to claim 16
wherein the providing of the database to the purchaser is also by digital media.

18. The personalized audio content rendering method according to claim 17
wherein the providing of the database by digital media is contemporaneous with the second-delivering and the first-delivering.

19. The personalized audio content rendering method according to claim 15
wherein the providing of the personalization computer program to the purchaser is via the Internet.

20. The personalized audio content rendering method according to claim 19
wherein the providing of the database to the purchaser is by digital media, as was the first-delivering of audio content of interest to children.

21. A digital medium interactive with (1) a computer and (2) a computer operator selecting a (3) child's proper name from (4) a database of content particularized to a multiplicity of children's proper names, so as to be both (A) self-altering, and (B) personalizing of its own content, the digital medium comprising:
contents of interest to children, this content initially being without personalization to the proper name of any one child;
a program executable on a computer (1) to receive from an operator of the computer a selected child's name and, in respect thereof, reference a database of content particularized to children's proper names so as to retrieve content relative to the selected particular child's name, and (2) to write this retrieved content onto the selfsame digital media so that it will be retrieved along with the contents of interest to a child upon playback of the digital media, and will produce upon this playback an output personalized to the child;
wherein the selfsame digital media contains both (1) content, and (2) a program executable to, by reference to a database, supplement this content;
wherein the digital media is, after execution of the program it contains, personalized to the selected child's name.

22. The digital medium according to claim 21 further comprising:
the database;
wherein each of the contents of interest to children, and program executable to personalize the digital medium, and the database are each, and all, on digital media.

23. The digital medium according to claim 21
wherein the contents of interest to children include at least audio content.

24. The digital medium according to claim 21
wherein execution of the program for personalization of the contents of the digital medium is performed but one time only, to personalize the content with but one single selected child's name

25. The digital medium according to claim 21 comprising:
an optical disk.
